(19) United States
(12) Patent Application Publication
(10) Pub. No.: US 2024/0343054 A1
(43) Pub. Date: Oct. 17, 2024

(54) DIGITAL INKJET TRANSFER PRINTING APPARATUS AND SYSTEM

(71) Applicant: Newtech Textile Technology Development (Shanghai) Co., LTD, Shanghai (CN)

(72) Inventor: Po-Wen CHUNG, Shanghai (CN)

(21) Appl. No.: 18/749,936

(22) Filed: Jun. 21, 2024

Related U.S. Application Data
(63) Continuation of application No. PCT/CN2023/126860, filed on Oct. 26, 2023.

(30) Foreign Application Priority Data
Feb. 23, 2023 (CN) 202310158812.8

(51) Int. Cl. B41M 5/025; B41J 2/005; B41J 2/01; B41M 5/03

(52) U.S. Cl. CPC B41M 5/0256; B41J 2/0057; B41M 5/03; B41J 2002/012

(57) ABSTRACT

A digital inkjet transfer printing apparatus used for performing transfer printing on fabrics by virtue of digital inkjet printing is provided. The digital inkjet transfer printing apparatus includes: a blanket inkjet printing assembly, where the blanket inkjet printing assembly includes a digital inkjet machine for ejecting ink to a surface of a blanket to form an ink pattern; and a counterpressure transfer printing assembly, where the counterpressure transfer printing assembly includes a press roller and a back-up roller, the press roller generates a pressure towards the back-up roller when a fabric enters a transfer printing area between the press roller and the back-up roller to press a surface to be printed of the fabric against a surface of the blanket with the ink pattern, so as to transfer the ink pattern on the blanket to the surface to be printed of the fabric.

### REFERENCE TO RELATED APPLICATION

The present application is a continuation of international application No. PCT/CN2023/126860, filed on Oct. 26, 2023, which claims the priority of CN application Ser. No. 20/231,0158812.8, filed on Feb. 23, 2023, the entirety of which are incorporated herein by reference.

### BACKGROUND OF THE DISCLOSURE

### Technical Field

The disclosure relates to a field of fabric printing and dyeing systems, and more particularly relates to a digital inkjet transfer printing apparatus and a digital inkjet transfer printing system including the digital inkjet transfer printing apparatus.

### Related Art

A printing process is a technical process where patterns are printed on fabrics with ink or pigments. Besides conventional rotary screen printing and flat screen printing, transfer printing has developed rapidly in recent years. Transfer printing includes: printing the pigments or ink on a transfer printing temporary carrier by a printing method first to prepare a transfer printing carrier; and then transferring the pigments or ink to the fabric by way of pressurization or high temperature and the like. The fabric obtained by transfer printing features bright colors, fine layers, vivid decorative patterns and high artistic quality. Transfer printing has realized, to a certain extent, cross-technological development by applying the printing technology to fabric printing.

A Chinese patent CN102817254A discloses a digital proofing method for cold transfer printing. However, in this method, printing and transferring are separated into two discontinuous steps which are completed by two sets of equipment, respectively, so that this method has obvious shortcomings. Moreover, the transfer printing temporary carrier is usually a disposable medium such as paper or a membrane, so that the cost cannot be lowered, and the requirement on low carbon consumption and environmental friendliness is not met.

### SUMMARY

An object of the disclosure is to provide a digital inkjet transfer printing apparatus and a digital inkjet transfer printing system including the digital inkjet transfer printing apparatus, which can overcome at least one deficiency in the related prior art.

A first aspect of the disclosure relates to a digital inkjet transfer printing apparatus, used for performing transfer printing on fabrics by virtue of digital inkjet printing. The digital inkjet transfer printing apparatus includes: a blanket inkjet printing assembly, where the blanket inkjet printing assembly includes a digital inkjet machine for ejecting ink to a surface of a blanket to form an ink pattern thereon; and a counterpressure transfer printing assembly, where the counterpressure transfer printing assembly includes a press roller and a back-up roller. The press roller is configured to generate a pressure facing the back-up roller when a fabric enters a transfer printing area between the press roller and the back-up roller to press a surface to be printed of the fabric towards the surface of the blanket with the ink pattern so as to transfer the ink pattern on the blanket to the surface to be printed of the fabric. The blanket may include an external transfer printing pressure bearing layer, the transfer printing pressure bearing layer is configured to generate vertical compression when a transfer printing pressure is applied onto the transfer printing pressure bearing layer, so as to avoid formation of a bulge at the blanket due to extrusion. A coating layer may be arranged on the transfer printing pressure bearing layer and is configured to adsorb the ink ejected by the digital inkjet machine.

A second aspect of the disclosure relates to a digital inkjet transfer printing apparatus, used for performing transfer printing on fabrics by virtue of digital inkjet printing. The digital inkjet transfer printing apparatus includes: a first blanket inkjet printing assembly and a second blanket inkjet printing assembly, where the first blanket inkjet printing assembly and the second blanket inkjet printing assembly each include a digital inkjet machine for ejecting ink to a surface of a blanket to form an ink pattern thereon; and a counterpressure transfer printing assembly, where the counterpressure transfer printing assembly includes a first press roller and a second press roller. The first press roller is set with the first blanket inkjet printing assembly and the second press roller is set with the second blanket inkjet printing assembly. The first press roller and the second press roller are configured to generate pressures facing each other when a fabric enters a transfer printing area between the first press roller and the second press roller to press a corresponding surface to be printed of the fabric against a corresponding surface of the blanket with the ink pattern, so that the ink pattern on the corresponding blanket is transferred to the corresponding surface to be printed of the fabric. The blanket may include an external transfer printing pressure bearing layer configured to generate vertical compression when a transfer printing pressure is applied onto the transfer printing pressure bearing layer so as to avoid formation of a bulge at the blanket due to extrusion. A coating layer may be arranged on the transfer printing pressure bearing layer and is configured to adsorb the ink ejected by the digital inkjet machine.

By using the blanket, the blanket may be used as a printing bearing temporary carrier to carry a printed digital inkjet pattern. Through a transfer printing process, the pattern is transferred to the fabric, thus realizing the integrated application of digital inkjet printing technology in the field of transfer printing. The blanket may be recycled, so that the printing cost is lowered, and the goal of low carbon consumption and environmental friendliness is realized. In addition, the fineness of the pattern and the ink carrying capacity may be improved through the transfer printing pressure bearing layer of the blanket and the coating layer arranged on the transfer printing pressure bearing layer.

In some embodiments, a thickness of the transfer printing pressure bearing layer may be 0.5-1.0 mm.

In some embodiments, the transfer printing pressure bearing layer may be formed by a pressure bearing layer sheet made of elastic rubber.

In some embodiments, a formulation (parts by weight) of the elastic rubber may be as follows:

| | |
|---|---|
| rubber | 50-100; |
| reinforcing filler | 20-40; |
| dibutyl phthalate | 15-30; |
| zinc stearate | 1.5-3; |
| zinc oxide | 1.5-3; |
| rubber accelerator | 1.5-3; |
| anti-aging agent RD | 0.5-1.5; |
| foaming agent | 3-9; and |
| vulcanizing agent sulfur | 0.5-1.5. |

In some embodiments, the rubber may be nitrile rubber, ethylene-propylene-diene monomer rubber, or natural rubber; and/or the reinforcing filler may be white carbon black or light calcium carbonate; and/or the rubber accelerator may be an accelerator M, or an accelerator D, or an accelerator CZ.

In some embodiments, the foaming agent may be a microsphere foaming agent, where the foaming agent is obtained by reactions of:
400-600 parts by mass, preferably 500 parts by mass, of a magnesium hydroxide aqueous dispersion;
1.5-2.5 parts by mass, preferably 2 parts by mass, of a sodium 2-ethylhexyl sulfate solution;
80-120 parts by mass, preferably 100 parts by mass, of acrylonitrile;
60-80 parts by mass, preferably 70 parts by mass, of methacrylonitrile;
30-50 parts by mass, preferably 40 parts by mass, of hydrocarbons;
0.8-1.2 parts by mass, preferably 1 part by mass, of 1,4-butanediol dimethacrylate; and
2.5-3.5 parts by mass, preferably 3 parts by mass, of dilauroyl peroxide.

In some embodiments, the magnesium hydroxide aqueous dispersion may contain 1.5 wt % of magnesium hydroxide, and/or the sodium 2-ethylhexyl sulfate solution may contain 1.5 wt % of sodium 2-ethylhexyl sulfate.

In some embodiments, the pressure bearing layer sheet and a blanket substrate are vulcanized in a stacked manner, preferably in a vulcanizing machine, so that the pressure bearing layer sheet is in composite connection to the blanket substrate, so as to form the transfer printing pressure bearing layer.

In some embodiments, the coating layer may be a rubber coating layer or a resin coating layer. Therefore, the rubber coating layer or the resin coating layer may be selected according to an actual demand.

In some embodiments, a material of the coating layer may be selected from the following materials: polyurethane rubber, nitrile rubber, chloroprene rubber, chlorosulfonated polyethylene rubber, ethylene propylene rubber, or flexographic resin.

In some embodiments, the coating layer may have at least one of the following features: the thickness of the coating layer is 2-20 mm, preferably 3-15 mm; and surface hardness of the coating layer is Shore hardness 45-90. By setting the parameters of the coating layer as mentioned above, a good pattern transfer printing quality may be realized.

In some embodiments, a surface structure of the blanket may be a carved surface structure, and the carved surface structure has at least one of the following features: a decorative pattern of the carved surface structure is round or polygonal, preferably rhombic, square, hexagonal, etc.; the number of lines of the carved surface structure is 10-800; a cell depth of the carved surface structure is 8-120 μm. The ink carrying capacity may be improved by arranging the carved surface structure. In addition, by setting the parameters of the carved surface structure as mentioned above, a good ink carrying effect may be realized.

In some embodiments, a length of the blanket may be substantially integer times of a pattern repeat length of the printed decorative pattern.

In some embodiments, the digital inkjet transfer printing apparatus may further include a cleaning device, where the cleaning apparatus is arranged on a downstream side of the counterpressure transfer printing assembly in a running direction of the blanket, and the cleaning device is configured to clean the surface of the blanket.

In some embodiments, the cleaning apparatus may include a spraying mechanism and a scraping mechanism, where the scraping mechanism is arranged on a downstream side of the spraying mechanism in the running direction of the blanket, the spraying mechanism is configured to spray a cleaning fluid to the blanket, and the scraping mechanism is configured to scrape off a liquid mixture remaining on the surface of the blanket. The blanket may be cleaned well by arranging the spraying mechanism. The liquid mixture remaining on the surface of the blanket may be scraped off as much as possible by arranging the scraping mechanism, so that the surface of the blanket can be free from liquid residues as much as possible, thereby well preparing for the next ink loading.

In some embodiments, the spraying mechanism may be equipped with a brush roller, where the brush roller is configured to brush off the ink on the surface of the blanket under a joint action with the cleaning fluid in a spraying area of the spraying mechanism. A better cleaning effect may be realized by additionally arranging the brush roller based on the spraying mechanism.

In some embodiments, the cleaning apparatus may include a liquid receiving tray, where the liquid receiving tray is arranged below the spraying mechanism and the scraping mechanism and has a discharge opening. The liquid receiving tray is for receiving liquid falling from above and discharging away the liquid from the liquid receiving tray. The falling liquid may be discharged in a targeted manner through the liquid receiving tray, so as to keep an operating environment away from being polluted by the cleaning liquid.

In some embodiments, the digital inkjet transfer printing apparatus may further include a coating mechanism, where the coating mechanism is arranged on an upstream side of the digital inkjet machine in the running direction of the blanket and is configured to apply a coating agent to the blanket to form the coating layer.

In some embodiments, the coating mechanism may be configured to be an air knife coating head, a blade coating head, a roller coating head, a curtain coating head or a slot-die coating head. Therefore, depending on the need in practice, different coating heads may be selected.

In some embodiments, the digital inkjet transfer printing apparatus may further include a first drying mechanism and/or a second drying mechanism, where the first drying mechanism is arranged between the cleaning apparatus and the coating mechanism in the running direction of the blanket, the second drying mechanism is arranged between the coating mechanism and the digital inkjet machine in the running direction of the blanket. The first drying mechanism and/or the second drying mechanism are configured to dry the blanket. By arranging the first drying mechanism after the cleaning apparatus, moisture remaining on the blanket may be removed, so that a dried surface of the blanket is provided for subsequent coating operation, thereby facilitating formation of the coating layer. By arranging the second drying mechanism after the coating mechanism, curing of the coating layer may be accelerated so as to obtain a good ink carrying capacity.

In some embodiments, the first drying mechanism and/or the second drying mechanism may be configured to be infrared radiation drying mechanisms for drying the blanket by way of infrared radiation or hot-air drying mechanisms for drying the blanket by hot air. By configuring the first drying mechanism and/or the second drying mechanism as the infrared radiation drying mechanisms or the hot-air drying mechanisms, the blanket may be dried rapidly in an appropriate manner.

In some embodiments, a tension control mechanism may be arranged on a side of the blanket opposite to the side where the digital inkjet machine is arranged, and the tension control mechanism is configured to adjust tension of the blanket in a digital inkjet printing area. The tension of the blanket in the digital inkjet printing area may be adjusted to an appropriate magnitude through the tension control mechanism.

In some embodiments, two tension rollers are symmetrically arranged about a center of the digital inkjet printing area. The tension of the blanket in the digital inkjet printing area may be adjusted in a targeted manner by symmetrically arranging the two tension rollers about the center of the digital inkjet printing area.

In some embodiments, a centering and correcting mechanism may be arranged on the upstream side of the digital inkjet machine in the running direction of the blanket, and the centering and correcting mechanism is configured to adjust a position of the blanket entering the digital inkjet printing area, so as to center the blanket. The blanket entering the digital inkjet printing area may be centered in an appropriate manner through the centering and correcting mechanism.

In some embodiments, multiple pairs of press rollers and back-up rollers are arranged along a feeding direction of the fabric. By arranging the multiple pairs of press rollers and back-up rollers, better single-sided transfer printing effect may be realized.

In some embodiments, multiple pairs of first press rollers and second press rollers may be arranged along the cloth feeding direction of the fabric. By arranging the multiple pairs of first press rollers and second press rollers, better double-sided transfer printing effect may be realized.

A third aspect of the disclosure relates to a digital inkjet transfer printing system, including a guiding assembly, where the digital inkjet transfer printing system also includes the digital inkjet transfer printing apparatus according to the disclosure, and the guiding assembly is configured to guide the fabric to pass through the digital inkjet transfer printing apparatus.

In the disclosure, the technology which realizes printing by combining digital inkjet with cold transfer printing through the medium (blanket) exerts the advantages of good decorative pattern fineness and digitalization of digital inkjet, and overcomes the deficiency that the type of fabrics applicable to digital inkjet is limited through cold transfer printing. In addition, by introducing the recyclable blanket, the consumption of transfer printing paper or membrane by cold transfer printing is overcame, and low carbon consumption and environmental friendliness are realized while the cost is lowered.

In addition, in the disclosure, in order to overcome deficiencies of poor ink carrying performance, low ink transfer rate, ghosted and blurred lines in a production process and the like of a conventional rubber blanket during application, the blanket of the present disclosure includes the transfer printing pressure bearing layer, where the transfer printing pressure bearing layer is arranged on the blanket substrate, and the coating layer is arranged on the transfer printing pressure bearing layer to improve the transfer printing quality. In an ink transfer impressing process of the transfer printing system, because the volume of the rubber of the conventional blanket will not be reduced when the rubber is pressed, the rubber only can deform for backward extrusion, so that a bulge is easily formed. Particularly during high-speed operation of the equipment, the blanket is subjected to alternating stress. In such case, the bulge formed at the first time has not been restored yet, the bulge formed by second compression is formed successively, which will inevitably cause deformation of printing dots. Thus, images and texts of a printed matter are blurred, ghosted, and doubled, or the reproducibility of a highlighted part is poor, which greatly affects the quality of the printed matter. The blanket according to the present disclosure includes the transfer printing pressure bearing layer, where an air cushion effect is formed inside the transfer printing pressure bearing layer by the foaming agent in the transfer printing pressure bearing layer. In a case that the transfer printing pressure is acted on the transfer printing pressure bearing layer, the transfer printing pressure bearing layer with the air cushion effect will generate vertical compression rather than form the bulge around in the blanket due to extrusion. Because the volumes of the microporous bubbles, which are uniformly distributed in the transfer printing pressure bearing layer, decreases after being pressed, an effect of vertical compression is generated. After the transfer printing pressure bearing layer is rolled, the closed microporous bubbles or air grooves are restored to their original shapes rapidly due to their internal pressure. Thus, deficiencies such as folds and streaks of the coating layer may be eliminated, so that the quality of the printed matter is greatly improved. Therefore, the blanket is applicable to high-speed production by the transfer printing apparatus provided by the present disclosure, and may print high-quality decorative patterns.

The above-mentioned technical features, the technical features to be mentioned below, and the technical features shown in the drawings may be combined with one another arbitrarily as long as the combined technical features are not contradictory. All technically feasible feature combinations are included in the recited technical contents of the specification.

### BRIEF DESCRIPTION OF THE DRAWINGS

The disclosure will be further described below with reference to schematic drawings and exemplary embodiments.

FIG. 1 is an overall schematic drawing of a digital inkjet transfer printing apparatus with a pair of press roller and back-up roller for single-sided printing according to an embodiment of the disclosure.

FIG. 2 is an overall schematic drawing of a digital inkjet transfer printing apparatus with multiple pairs of press rollers and back-up rollers for single-sided printing according to another embodiment of the disclosure.

FIG. 3 is an overall schematic drawing of a digital inkjet transfer printing apparatus with multiple pairs of first press rollers and second press rollers for double-sided printing according to another embodiment of the disclosure.

### DETAILED DESCRIPTION

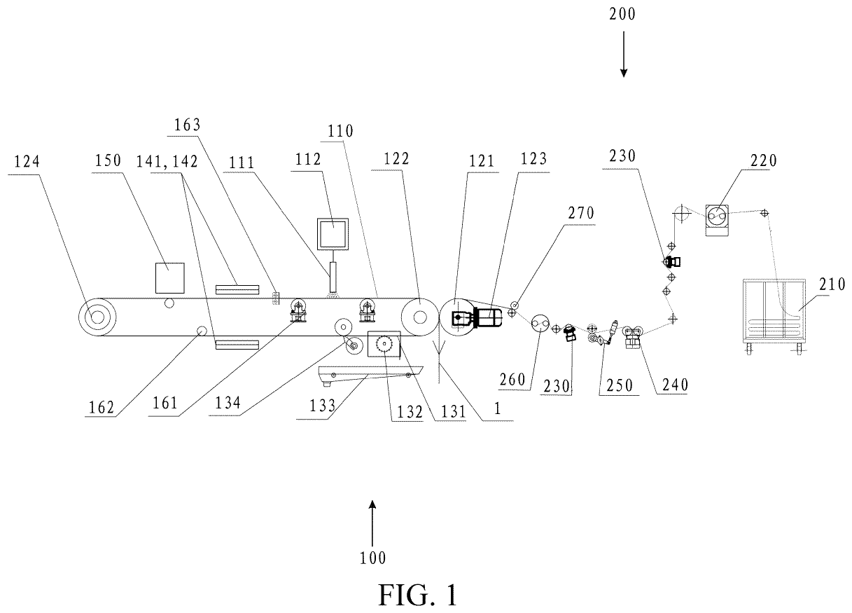

As shown in FIG. 1 to FIG. 3, a digital inkjet transfer printing system includes a guiding assembly 200, where the guiding assembly 200 is configured to guide a fabric 1 to pass through a digital inkjet transfer printing apparatus 100. The guiding assembly 200 will be described in further detail below.

In the embodiment shown in FIG. 1, the digital inkjet transfer printing apparatus 100 includes a blanket inkjet printing assembly and a counterpressure transfer printing assembly. The counterpressure transfer printing assembly includes a press roller 121 and a back-up roller 122. The blanket inkjet printing assembly includes a blanket 110 which can circulate in a loop for carrying a printed pattern and a digital inkjet machine 111 for ejecting ink to a surface of the blanket 110. The blanket 110 circulates around the peripheries of a driving roller 124 and the back-up roller 122 and passes through a transfer printing area between the press roller 121 and the back-up roller 122. At the same time, the fabric 1 guided by the guiding assembly 200 also passes through the transfer printing area between the press roller 121 and the back-up roller 122. When the fabric 1 enters the transfer printing area between the press roller 121 and the back-up roller 122, the press roller 121 generates a pressure towards the back-up roller 122 to press a surface to be printed of the fabric 1 against the blanket 110, so as to transfer an ink pattern on the blanket 110 to a side of the fabric 1. Therefore, single-sided transfer printing of the fabric 1 may be realized.

Inkjet parameters may be inputted into the digital inkjet machine 111 through a computer 112, so as to control the digital inkjet machine 111 to perform an inkjet operation.

As shown in FIG. 1, the driving roller 124 may drive the blanket 110 and jointly cooperate with the back-up roller 122 to make the blanket 110 circulate.

It may be seen clearly from FIG. 1 that the press roller 121 may be equipped with a pressurizing motor 123. The pressurizing motor 123 may press the press roller 121 toward the back-up roller 122 to generate a pressure for pressing the surface to be printed of the fabric 1 against the blanket 110. A tangent point of the press roller 121 and the back-up roller 122 and a connecting line between the centers of circle of the press roller 121 and the back-up roller 122 are on a same straight line. The press roller 121 and the back-up roller 122 are arranged in a pair in a feeding direction of the fabric 1, where the connecting line between the centers of circle of the press roller 121 and the back-up roller 122 is substantially perpendicular to the feeding direction of the fabric 1. In the embodiment shown in FIG. 1, one pair of press roller 121 and back-up roller 122 is arranged.

The blanket 110 includes an external transfer printing pressure bearing layer configured to generate vertical compression when a transfer printing pressure is applied onto the transfer printing pressure bearing layer, so as to avoid formation of a bulge at the blanket due to extrusion. The transfer printing pressure bearing layer may be formed by a pressure bearing layer sheet made of elastic rubber. The transfer printing pressure bearing layer may be formed in the following ways: a layer of elastic rubber is attached to a calender machine, where the temperature of cylinders of the calender machine is set at 60-90° C.; the elastic rubber is calendered; and the calendered elastic rubber is then placed on a drum vulcanizer for vulcanization. The vulcanized sheet is ground on a grinder to generate a pressure bearing layer sheet. The pressure bearing layer sheet and a blanket substrate are vulcanized in a stacked manner in the vulcanizing machine, so that the pressure bearing layer sheet is in composite connection to the blanket substrate, so as to form the transfer printing pressure bearing layer. Here, a formulation (parts by weight) of the elastic rubber may be as follows: 50-100 parts of rubber; 20-40 parts of a reinforcing filler; 15-30 parts of dibutyl phthalate; 1.5-3 parts of zinc stearate; 1.5-3 parts of zinc oxide; 1.5-3 parts of a rubber accelerator; 0.5-1.5 parts of an anti-aging agent RD; 3-9 parts of a foaming agent; and 0.5-1.5 parts of a vulcanizing agent sulfur. The rubber is nitrile rubber, the reinforcing filler is white carbon black, and the rubber accelerator is an accelerator M. Of course, the rubber, the reinforcing filler, and the rubber accelerator may also be other applicable substances. The foaming agent may be a microsphere foaming agent, where the foaming agent is obtained by reactions of 500 parts by mass of a magnesium hydroxide aqueous dispersion and 2 parts by mass of a sodium 2-ethylhexyl sulfate solution, and 100 parts by mass of acrylonitrile, 70 parts by mass of methacrylonitrile, 40 parts by mass of hydrocarbons, 1 part by mass of 1,4-butanediol dimethacrylate and 3 parts by mass of dilauroyl peroxide. The above various substances, as a mixture, are emulsified in a high-shear mixer (room temperature, 8000 rpm) for 45 s; then, the mixture is mildly stirred for 20 h (˜60° C., ˜800 rpm) in a reactor; and then the mixture is cooled to room temperature. After the reaction is stopped, the dispersion liquid is subjected to a 100 μm sieve to remove any agglomerates and large particles, and finally, microspheres are filtered and collected and are dried at 50° C. and then left stand overnight to obtain the foaming agent. The magnesium hydroxide aqueous dispersion may contain 1.5 wt % of magnesium hydroxide, and/or the sodium 2-ethylhexyl sulfate solution may contain 1.5 wt % of sodium 2-ethylhexyl sulfate.

A coating layer such as an ink adsorbing coating for adsorbing ink is arranged on the transfer printing pressure bearing layer. The coating layer may be a rubber coating layer or a resin coating layer. A material of the coating layer may be selected from the following materials: polyurethane rubber, nitrile rubber, chloroprene rubber, chlorosulfonated polyethylene rubber, ethylene propylene rubber, or flexographic resin. The thickness of the coating layer may be 2-20 mm, preferably 3-15 mm. Surface hardness of the coating layer is Shore hardness 45-90. A surface structure of the blanket 110 may be a smooth surface or a carved surface structure. In a case of the carved surface structure, a decorative pattern of the carved surface structure may be round or polygonal, for example, rhombic, square and hexagonal. Of course, other polygonal shapes may also be applicable. The number of lines of the carved surface structure may be 10-800, preferably 20-600. A cell depth of the carved surface structure may be 8-120 μm, preferably 10-100 μm. A length of the blanket 110 is substantially integer times of a pattern repeat length of the printed decorative pattern.

In order to form the coating layer, the digital inkjet transfer printing apparatus 100 further includes a coating mechanism 150. The coating mechanism 150 is configured to apply a coating agent to the blanket 110. The coating mechanism 150 is arranged on an upstream side of the digital inkjet machine 111 in the running direction of the blanket 110. The coating mechanism 150 may form the surface structure with different patterns or decorative patterns on the blanket 110 as mentioned above. The coating mechanism 150 may be an air knife coating head, a blade coating head, a roller coating head, a curtain coating head or a slot-die coating head.

The digital inkjet transfer printing apparatus 100 further includes a cleaning apparatus, where the cleaning apparatus is arranged on a downstream side of the counterpressure transfer printing assembly in a running direction of the blanket 110 and is configured to clean the surface of the blanket 110. Ink is ejected by the digital inkjet machine 111 to the blanket 110 and some ink will be remaining on the surface after ink is transfer printed to the fabric 1. Therefore, the blanket 110 needs to be cleaned to prevent it from affecting subsequent transfer printing of the fabric 1. To this end, the cleaning apparatus includes a spraying mechanism 131 and a scraping mechanism 134. The scraping mechanism 134 is arranged on a downstream side of the spraying mechanism 131 in the running direction of the blanket 110. The spraying mechanism 131 is configured to spray a cleaning fluid such as water to the blanket 110. The spraying mechanism 131 may be configured to be a spray pipe. The scraping mechanism 134 is configured to scrape off a liquid mixture remaining on the surface of the blanket 110. The scraping mechanism 134 may be, for example, a scraper. Besides the spraying mechanism 131 and the scraping mechanism 134, the spraying mechanism 131 may be further equipped with a brush roller 132. The brush roller 132 is configured to brush off the ink on the surface of the blanket 110 under a joint action with the cleaning fluid in a spraying area of the spraying mechanism 131. The brush roller 132 may be a hairbrush roller. Of course, brush rollers 132 in other forms may also be applicable. A liquid receiving tray 133 is arranged below the spraying mechanism 131 and the scraping mechanism 134 for receiving the liquid falling from above. The liquid receiving tray 133 has a discharge opening for discharging away the liquid from the liquid receiving tray 133. The liquid receiving tray 133 may have an inclined receiving surface, and the discharge opening may be formed in the lowest part of the receiving surface.

The digital inkjet transfer printing apparatus 100 may further include a first drying mechanism 141 and a second drying mechanism 142. The first drying mechanism 141 is arranged between the cleaning apparatus and the coating mechanism 150 in the running direction of the blanket 110. The second drying mechanism 142 is arranged between the coating mechanism 150 and the digital inkjet machine 111 in the running direction of the blanket 110. The first drying mechanism 141 and the second drying mechanism 142 are configured to dry the blanket 110. In other embodiments, the first drying mechanism 141 or the second drying mechanism 142 may also be arranged only. The first drying mechanism 141 and the second drying mechanism 142 may be configured to be infrared radiation drying mechanisms for drying the blanket 110 by way of infrared radiation or hot-air drying mechanisms for drying the blanket 110 by hot air. In other embodiments, the first drying mechanism 141 or the second drying mechanism 142 may also be configured to blow-dry the blanket 110 by normal temperature air.

A guide roller 162 is arranged between the scraping mechanism 134 and the driving roller 124 in the running direction of the blanket 110. The guide roller 162 is configured to guide the blanket 110 when the blanket 110 moves from the scraping mechanism 134 toward the driving roller 124. The guide roller 162 may make the blanket 110 deflect.

A tension control mechanism 161 may be arranged on a side, opposite to the side where the digital inkjet machine 111 is arranged, of the blanket 110. The tension control mechanism 161 is configured to adjust tension of the blanket 110 in a digital inkjet printing area. As shown in FIG. 1, two tension rollers are symmetrically arranged about a center of the digital inkjet printing area. The two tension rollers are configured to adjust the blanket 110 to have appropriate tension in the digital inkjet printing area, thereby realizing a good ink carrying effect.

In order to center the blanket 110 entering the digital inkjet printing area, a centering and correcting mechanism 163 is arranged on an upstream side of the digital inkjet machine 111, particularly an upstream side of the two tension rollers, in the running direction of the blanket 110. The centering and correcting mechanism 163 is configured to adjust the position of the blanket 110 entering the digital inkjet printing area.

As shown in FIG. 1, the guiding assembly 200 may include a cloth cart 210, a first spreader and separator roller 220, a tension control roller 230, a correcting and aligning apparatus 240, a traction apparatus 250, a second spreader and separator roller 260, and a feed liquid pre-treatment apparatus 270 arranged in sequence in a running direction of the fabric 1. Multiple deflector rollers may be arranged in a traveling route of the fabric 1, so that the fabric 1 deflects appropriately, and the overall equipment may be designed compactly. The guiding assembly 200 may have more or less deflector rollers according to an actual demand.

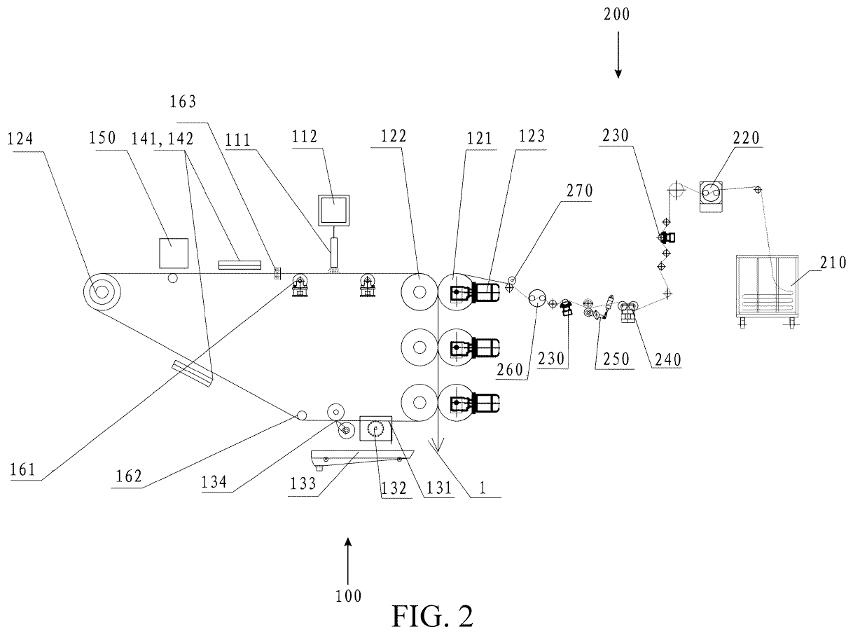

The digital inkjet transfer printing apparatus 100 shown in FIG. 2 similar to the digital inkjet transfer printing apparatus 100 shown in FIG. 1 is also used for single-sided printing. The difference between the two embodiments is as follows: the counterpressure transfer printing assembly of the digital inkjet transfer printing apparatus 100 shown in FIG. 2 includes three pairs of press rollers 121 and back-up rollers 122, that is, three press rollers 121 and three back-up rollers 122. The three pairs of press rollers 121 and back-up rollers 122 are arranged in succession along a feeding direction of the fabric 1. A better transfer printing effect may be realized by arranging the multiple pairs of press rollers 121 and back-up rollers 122.

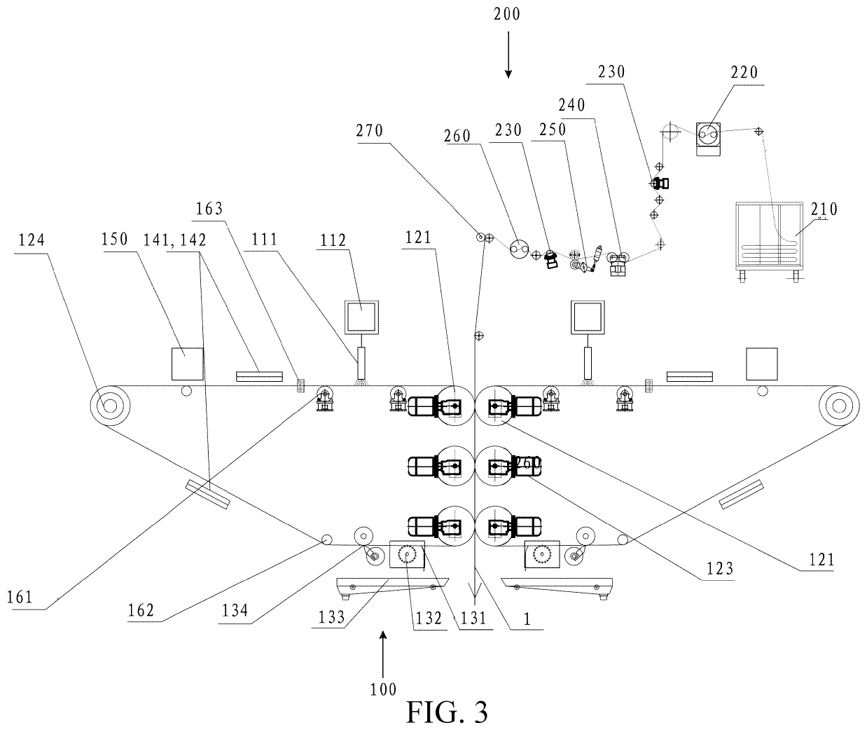

The digital inkjet transfer printing apparatus 100 shown in FIG. 3 is used for double-sided printing. The digital inkjet transfer printing apparatus 100 includes a first blanket inkjet printing assembly and a second blanket inkjet printing assembly. The first blanket inkjet printing assembly and the second blanket inkjet printing assembly may be configured like the blanket inkjet printing assembly in the embodiment shown in FIG. 1. It can be seen clearly from FIG. 3 that the first blanket inkjet printing assembly and the second blanket inkjet printing assembly may be arranged in a mirror symmetry manner about the feeding direction of the fabric 1. The digital inkjet transfer printing apparatus 100 for double-sided printing includes a counterpressure transfer printing assembly having a first press roller and a second press roller, where the first press roller is set with the first blanket inkjet printing assembly, and the second press roller is set with the second blanket inkjet printing assembly. The corresponding blanket 110 circulates around the peripheries of the corresponding driving roller 124 and the corresponding press roller 121. The first press roller and the second press roller are configured to generate pressures facing each other when the fabric 1 enters the transfer printing area between the first press roller and the second press roller, thereby pressing a corresponding surface to be printed of the fabric 1 against a corresponding blanket 110. Accordingly, a dye pattern on the corresponding blanket 110 is transferred to the corresponding side of the fabric 1, and thus, double-sided printing is realized.

The disclosure will be further described below through non-restrictive embodiments. It shall be noted that these embodiments shall not be regarded as limitations on the disclosure.

Embodiment 1: a digital inkjet blanket transfer printing apparatus with one press roller 121 on a single side.

The digital inkjet blanket transfer printing apparatus with one press roller 121 on a single side includes a frame, a guiding assembly 200, a blanket inkjet printing assembly, and a counterpressure transfer printing assembly. The counterpressure transfer printing assembly is formed by the press roller 121 equipped with a pressurizing motor 123 and the back-up roller 122.

The blanket inkjet printing assembly includes a seamless annular blanket 110, a driving roller 124, a tension control mechanism 161, a centering and correcting mechanism 163, a coating mechanism 150, a drying mechanism, a digital inkjet machine 111 connected to a computer, a cleaning apparatus, and a guide roller 162.

The guiding assembly 200 includes a cloth cart 210, a first spreader and separator roller 220, a tension control roller 230, a correcting and aligning apparatus 240, a traction apparatus 250, a second spreader and separator roller 260, and a feed liquid pre-treatment apparatus 270. The feed liquid pre-treatment apparatus 270 may be a fabric feed liquid treatment apparatus in a Chinese patent with application Ser. No. 20/052,0044826.4, 200920066843.6, 201510391008.X, 201611223321.3, or 201611223332.1, or a fabric feed liquid treatment apparatus applicable in the field.

The driving roller 124 drives the blanket 110 to move.

The blanket 110 encircles the peripheries of the driving roller 124 and the back-up roller 122. The blanket 110 includes a transfer printing pressure bearing layer, where a rubber coating layer is arranged on the transfer printing pressure bearing layer. The thickness of the rubber coating layer may be 3-15 mm; the rubber may be polyurethane rubber, nitrile rubber, chloroprene rubber, chlorosulfonated polyethylene rubber, or ethylene propylene rubber, with surface hardness of Shore hardness 45-90.

A length of the blanket 110 is substantially integer times of a pattern repeat length of the printed decorative pattern.

The cleaning apparatus may include a spray pipe, a hairbrush roller, a scraper, and a water pan.

The drying mechanism may be an infrared radiation drying mechanism or a hot-air drying mechanism.

The coating mechanism 150 may be an air knife coating head, a blade coating head, a roller coating head, a curtain coating head, or a slot-die coating head.

The back-up roller 122, the cleaning apparatus, the first drying mechanism 141, the driving roller 124, the coating mechanism 150, the second drying mechanism 142, the centering and correcting mechanism 163, a first tension roller, a digital inkjet printing area, and a second tension roller are arranged along the blanket 110 in sequence.

A tangent point of the press roller 121 and the back-up roller 122 and a connecting line between the centers of circle of the two rollers are on a same straight line. The fabric 1 and the blanket 110 pass between the press roller 121 and the back-up roller 122. The press roller 121 and the back-up roller 122, which are 1 pair of press roller 121 and the back-up roller 122, are arranged in pairs perpendicular to the feeding direction of the fabric 1.

The digital inkjet blanket transfer printing apparatus includes a set of guiding assembly 200, a set of blanket inkjet printing assembly, and a counterpressure transfer printing assembly formed by the pair of the press roller 121 equipped with the pressurizing motor 123 and the back-up roller 122. The digital inkjet blanket transfer printing apparatus may perform single-sided printing for the fabric.

The blanket 110 is coated by the coating head in coating mechanism 150 with an ink adsorbing coating material. After the blanket 110 is dried by the drying mechanism, the position of the blanket 110 is adjusted by the centering and correcting mechanism 163. The blanket 110 enters the digital inkjet printing area after the tension of the blanket 110 is adjusted by the tension control mechanism 161. In the digital inkjet printing area, the digital inkjet machine 111 prints the pattern to the surface of the blanket 110 with the ink adsorbing coating through the ink according to a pattern and a color blending solution designed in a computer 112. The blanket 110 is subjected to the transfer printing process conducted by the counterpressure transfer printing assembly. The ink and the pattern are transferred to the fabric 1. After the transfer printed blanket 110 is cleaned by the cleaning apparatus and the surface of the blanket is dried by the drying mechanism, the blanket 110 is then subjected to cyclic steps of coating, inkjet printing, and transfer printing.

The fabric 1 is conveyed by the guiding assembly 200. Subjected to feed liquid pre-treatment by the feed liquid pre-treatment apparatus 270, the fabric 1 enters the transfer printing area between the press roller 121 and the back-up roller 122. The press roller 121 is pressurized by the pressurizing motor 123. The surface to be printed of the fabric 1 and the blanket 110 are in press fit, so that the ink pattern on the blanket 110 is transferred to the fabric 1. Then the fabric 1 is subjected to conventional color fixing, washing, and shaping to obtain a product.

Embodiment 2: a digital inkjet blanket transfer printing apparatus with multiple press rollers 121 on a single side.

The digital inkjet blanket transfer printing apparatus with multiple press rollers 121 on a single side includes a frame, a guiding assembly 200, a blanket inkjet printing assembly, and a counterpressure transfer printing assembly formed by the press rollers 121 equipped with the pressurizing motors 123 and the back-up rollers 122.

The blanket inkjet printing assembly and the guiding assembly 200 of the digital inkjet blanket transfer printing apparatus with multiple press rollers 121 on a single side are as same as those in the embodiment 1. The press rollers 121 and the back-up rollers 122, which are 3 pairs of press rollers 121 and back-up rollers 122, are arranged in pairs perpendicular to a feeding direction of a fabric 1. The digital inkjet blanket transfer printing apparatus includes a set of guiding assembly 200, a set of blanket inkjet printing assembly, and a counterpressure transfer printing assembly formed by 3 pairs of press rollers 121 and back-up rollers 122, where each of the press rollers 121 is equipped with the pressurizing motor 123. The digital inkjet blanket transfer printing apparatus may perform single-sided printing for the fabric.

Embodiment 3: a digital inkjet blanket transfer printing apparatus with multiple press rollers 121 on double sides.

The digital inkjet blanket transfer printing apparatus with multiple press rollers 121 on double sides includes a frame, a guiding assembly 200, a blanket inkjet printing assembly, and a counterpressure transfer printing assembly formed by the press rollers 121 equipped with the pressurizing motors 123 and the back-up rollers 122.

The blanket inkjet printing assembly and the guiding assembly 200 of the digital inkjet blanket transfer printing apparatus with multiple press rollers 121 on double sides are same as those in the embodiment 1. The digital inkjet blanket transfer printing apparatus with multiple press rollers 121 on double sides includes a set of guiding assembly 200, two sets of oppositely arranged blanket inkjet printing assemblies, and a counterpressure transfer printing assembly formed by 3 pairs of two oppositely arranged press rollers 121, where each of the press rollers 121 is equipped with the pressurizing motors 123. The digital inkjet blanket transfer printing apparatus with multiple press rollers on double sides may perform double-sided printing for the fabric.

It is to be noted that the terms used herein are merely used for a purpose of describing specific aspects, rather than, limiting the contents of the disclosure. As used herein, the singular forms “a”, “an”, and “the” shall include the plural forms, unless the context explicitly expressed otherwise. It may be understood that the terms “including” and “comprising”, and other similar terms used herein specifically describe existence of operations, elements and/or components stated, without excluding existence or addition of one or more other operations, elements, components and/or combinations thereof. As used herein, the term “and/or” includes all arbitrary combinations of one or more relevant listed items. In the description of the drawings, similar reference numerals refer to similar elements throughout.

The thickness of the elements in the drawings, for clarity, may be exaggerated. In addition, it may be understood that if an element is considered as being on another element, coupled with another element or connected to another element, the element may be directly formed on the other element, coupled with or connected to the other element, or there may be one or more elements therebetween. On the contrary, the expressions “directly on”, “directly coupled with”, and “directly connected to” used herein indicate that there are no elements therebetween. Other words, for example, “between”, “directly between”, “attached to” and “directly attached to”, “adjacent to” and “directly adjacent to”, for describing relationships among the elements shall be explained similarly.

The terms here, for example, “top”, “bottom”, “above”, “below”, “on” and “underneath”, are used for describing relationships of an element, a layer or an area shown in the drawings relative to another element, layer or area. It may be understood that besides orientations described in the drawings, these terms shall also include other orientations of the apparatus.

It may be understood that although the terms “first”, “second” and the like may be used to describe different elements, these elements shall not be limited by these terms. These terms are merely used to distinguish an element from another element. Therefore, the first element may also be called a second element, without departing from teaching of the concept of the disclosure.

It may also be considered that all exemplary embodiments disclosed herein may be combined with one another arbitrarily. It is to be noted finally that the above embodiments are merely used to understand the disclosure, rather than, limit the scope of protection of the disclosure. A person skilled in the art may make modifications on the basis of the above embodiments, and these modifications shall all fall within the scope of protection of the disclosure.

What is claimed is:

1. A digital inkjet transfer printing apparatus, used for performing transfer printing on fabrics by virtue of digital inkjet printing, wherein the digital inkjet transfer printing apparatus comprises:
a blanket inkjet printing assembly, wherein the blanket inkjet printing assembly comprises a digital inkjet machine for ejecting ink to a surface of a blanket to form an ink pattern on the surface of the blanket; and
a counterpressure transfer printing assembly, comprising a press roller and a back-up roller, wherein the press roller is configured to generate a pressure towards the back-up roller when a fabric enters a transfer printing area between the press roller and the back-up roller to press a surface to be printed of the fabric against the surface of the blanket with the ink pattern, so as to transfer the ink pattern on the blanket to the surface to be printed of the fabric,
wherein the blanket comprises an external transfer printing pressure bearing layer configured to generate vertical compression when a transfer printing pressure is applied onto the transfer printing pressure bearing layer, so as to avoid formation of a bulge at the blanket due to extrusion; and
a coating layer is arranged on the transfer printing pressure bearing layer and the coating layer is configured to adsorb the ink ejected by the digital inkjet machine.

2. A digital inkjet transfer printing apparatus, used for performing transfer printing on fabrics by virtue of digital inkjet printing, wherein the digital inkjet transfer printing apparatus comprises:
a first blanket inkjet printing assembly and a second blanket inkjet printing assembly, wherein the first blanket inkjet printing assembly and the second blanket inkjet printing assembly each comprise a digital inkjet machine for ejecting ink to a surface of a blanket to form an ink pattern on the surface of the blanket; and
a counterpressure transfer printing assembly, comprising a first press roller and a second press roller, wherein the first press roller is set with the first blanket inkjet printing assembly and the second press roller is set with the second blanket inkjet printing assembly; the first press roller and the second press roller are configured to generate pressures towards each other when a fabric enters a transfer printing area between the first press roller and the second press roller to press a corresponding surface to be printed of the fabric against a corresponding surface of the blanket with the ink pattern, so that the ink pattern on the corresponding blanket is transferred to the corresponding surface to be printed of the fabric;
the blanket comprises an external transfer printing pressure bearing layer configured to generate vertical compression when a transfer printing pressure is applied onto the transfer printing pressure bearing layer so as to avoid formation of a bulge at the blanket due to extrusion; and
a coating layer is arranged on the transfer printing pressure bearing layer and the coating layer is configured to adsorb the ink ejected by the digital inkjet machine.

3. The digital inkjet transfer printing apparatus according to claim 1, wherein a thickness of the transfer printing pressure bearing layer is 0.5-1.0 mm, and/or
the transfer printing pressure bearing layer is formed by a pressure bearing layer sheet made of elastic rubber, and/or
a formulation (parts by weight) of the elastic rubber is as follows:

| | |
|---|---|
| rubber | 50-100; |
| reinforcing filler | 20-40; |
| dibutyl phthalate | 15-30; |
| zinc stearate | 1.5-3; |
| zinc oxide | 1.5-3; |
| rubber accelerator | 1.5-3; |
| anti-aging agent RD | 0.5-1.5; |
| foaming agent | 3-9; and |
| vulcanizing agent sulfur | 0.5-1.5; |

and/or
the rubber is nitrile rubber, ethylene-propylene-diene monomer rubber, or natural rubber; and/or
the reinforcing filler is white carbon black or light calcium carbonate; and/or
the rubber accelerator is an accelerator M, or an accelerator D, or an accelerator CZ; and/or
the foaming agent is a microsphere foaming agent, wherein the foaming agent is obtained by reactions of 400-600 parts by mass of a magnesium hydroxide aqueous dispersion, 1.5-2.5 parts by mass of a sodium 2-ethylhexyl sulfate solution, 80-120 parts by mass of acrylonitrile, 60-80 parts by mass of methacrylonitrile, 30-50 parts by mass of hydrocarbons, 0.8-1.2 parts by mass of 1,4-butanediol dimethacrylate and 2.5-3.5 parts by mass of dilauroyl peroxide, wherein the magnesium hydroxide aqueous dispersion contains 1.5 wt % of magnesium hydroxide, and/or the sodium 2-ethylhexyl sulfate solution contains 1.5 wt % of sodium 2-ethylhexyl sulfate, and/or
the transfer printing pressure bearing layer is formed through the process that the pressure bearing layer sheet and a blanket substrate are vulcanized in a stacked manner, so that the pressure bearing layer sheet is in composite connection to the blanket substrate.

4. The digital inkjet transfer printing apparatus according to claim 1, wherein the coating layer is configured to be a rubber coating layer or a resin coating layer, and/or
a material of the coating layer is selected from the following materials: polyurethane rubber, nitrile rubber, chloroprene rubber, chlorosulfonated polyethylene rubber, ethylene propylene rubber, or flexographic resin, and/or
the coating layer has at least one of the following features:
the thickness of the coating layer is 2-20 mm;
surface hardness of the coating layer is Shore hardness 45-90, and/or
a surface structure of the blanket is a carved surface structure, and the carved surface structure has at least one of the following features:
a decorative pattern of the carved surface structure is round or polygonal;
the number of lines of the carved surface structure is 10-800;
a cell depth of the carved surface structure is 8-120 μm, and/or
a length of the blanket is substantially integer times of a pattern repeat length of the printed decorative pattern.

5. The digital inkjet transfer printing apparatus according to claim 1, further comprising a cleaning apparatus, wherein the cleaning apparatus is arranged on a downstream side of the counterpressure transfer printing assembly in a running direction of the blanket, and is configured to clean the surface of the blanket; and/or
the cleaning apparatus comprises a spraying mechanism and a scraping mechanism, wherein the scraping mechanism is arranged on a downstream side of the spraying mechanism in the running direction of the blanket, the spraying mechanism is configured to spray a cleaning fluid to the blanket, and the scraping mechanism is configured to scrape off a liquid mixture remaining on the surface of the blanket; and/or
the spraying mechanism is equipped with a brush roller, wherein the brush roller is configured to brush off the ink on the surface of the blanket under a joint action with the cleaning fluid in a spraying area of the spraying mechanism; and/or
the cleaning apparatus comprises a liquid receiving tray, wherein the liquid receiving tray is arranged below the spraying mechanism and the scraping mechanism, and the liquid receiving tray has a discharge opening for receiving a liquid falling from above and draining away the liquid from the liquid receiving tray.

6. The digital inkjet transfer printing apparatus according to claim 1, further comprising a coating mechanism, wherein the coating mechanism is arranged on an upstream side of the digital inkjet machine in a running direction of the blanket and is configured to apply a coating agent to the blanket to form the coating layer; and/or
the coating mechanism is configured to be an air knife coating head, a blade coating head, a roller coating head, a curtain coating head or a slot-die coating head; and/or
the digital inkjet transfer printing apparatus further comprises a first drying mechanism and/or a second drying mechanism, wherein the first drying mechanism is arranged between the cleaning apparatus and the coating mechanism in the running direction of the blanket, the second drying mechanism is arranged between the coating mechanism and the digital inkjet machine in the running direction of the blanket, and the first drying mechanism and/or the second drying mechanism are configured to dry the blanket; and/or
the first drying mechanism and/or the second drying mechanism are configured to be a infrared radiation drying mechanism for drying the blanket by way of infrared radiation or a hot-air drying mechanism for drying the blanket by hot air.

7. The digital inkjet transfer printing apparatus according to claim 1, wherein a tension control mechanism is arranged on a side, opposite to a side where the digital inkjet machine is arranged, about the blanket, and is configured to adjust tension of the blanket in a digital inkjet printing area; and/or
two tension rollers are symmetrically arranged about a center of the digital inkjet printing area; and/or
a centering and correcting mechanism is arranged on the upstream side of the digital inkjet machine in the running direction of the blanket, and is configured to adjust a position of the blanket entering the digital inkjet printing area, so as to center the blanket.

8. The digital inkjet transfer printing apparatus according to claim 1, wherein multiple pairs of press rollers and back-up rollers are arranged along a feeding direction of the fabric.

9. The digital inkjet transfer printing apparatus according to claim 2, wherein multiple pairs of first press rollers and second press rollers are arranged along a feeding direction of the fabric.

10. A digital inkjet transfer printing system, comprising a guiding assembly, wherein the digital inkjet transfer printing system further comprises the digital inkjet transfer printing apparatus according to claim 1, and the guiding assembly is configured to guide the fabric to pass through the digital inkjet transfer printing apparatus.
